(19) United States
(12) Patent Application Publication
(10) Pub. No.: US 2026/0122476 A1
(43) Pub. Date: Apr. 30, 2026

(54) METHOD AND APPARATUS FOR ENHANCING MULTIPLE-INPUT MULTIPLE-OUTPUT OPERATION IN MOBILE COMMUNICATIONS

(71) Applicant: MEDIATEK INC., Hsinchu City (TW)

(72) Inventors: Chun-Fan TSAI, Hsinchu City (TW); Lung-Sheng TSAI, Hsinchu City (TW); Cheng-Rung TSAI, Hsinchu City (TW)

(21) Appl. No.: 19/166,135

(22) PCT Filed: May 22, 2024
(86) PCT No.: PCT/CN2024/094594

§ 371 Date: Sep. 17, 2025

Related U.S. Application Data
(60) Provisional application No. 63/468,019, filed on May 22, 2023.

(51) Int. Cl. H04W 8/24; H04B 7/06; H04W 24/08

(52) U.S. Cl. CPC H04W 8/24; H04B 7/0628; H04W 24/08

(57) ABSTRACT

Various solutions for enhancing multiple-input multiple-output (MIMO) operation with respect to user equipment and network apparatus in mobile communications are described. An apparatus may receive a capability enquiry in a first frequency from a network node. The apparatus may transmit a capability report to the network node to indicate a supportability of a data forwarding operation with a collaborating apparatus in a second frequency. The apparatus may receive a configuration to enable or disable the data forwarding operation with the collaborating apparatus. The apparatus may perform the data forwarding operation according to the configuration.

### CROSS REFERENCE TO RELATED PATENT APPLICATION(S)

The present disclosure is part of a non-provisional application claiming the priority benefit of U.S. Patent Application No. 63/468,019, filed 22 May 2023, the content of which herein being incorporated by reference in its entirety.

### TECHNICAL FIELD

The present disclosure is generally related to mobile communications and, more particularly, to enhancing multiple-input multiple-output (MIMO) operation with respect to primary user equipment (UE), collaborating UE and network apparatus in mobile communications.

### BACKGROUND

Unless otherwise indicated herein, approaches described in this section are not prior art to the claims listed below and are not admitted as prior art by inclusion in this section.

MIMO is an antenna technology for wireless communications in which multiple antennas are used at both the source (e.g., transmitter) and the destination (e.g., receiver). The antennas at each end of the communication apparatus are combined to minimize errors, optimize data throughput and improve the capacity of radio transmissions by enabling data to travel over many signal paths at the same time. Creating multiple versions of the same signal provides more opportunities for the data to reach the receiving antenna without being affected by fading, which improves the signal-to-noise ratio and error rate. By boosting the capability of radio frequency (RF) systems, MIMO technology can create a more stable connection, less congestion and high data throughput.

In mobile communication system, if a UE could support high number of MIMO layer, it could have diversity gain or multiplexing gain. However, the number of available MIMO layer is limited by channel quality between the based station and the UE. In addition, hardware and/or software limitations and power limitations of the UE could also limit the MIMO capability of the UE. Therefore, if there is another UE-controlled device (e.g., collaborative UE/panel or repeater) that could help forwarding the data/signaling via another frequency, it could increase the effective number of MIMO layer and boost the MIMO performance significantly.

To support data forwarding via another frequency (e.g., forwarding Uu interface data in frequency f1 by using frequency f2, and vice versa), there is a need for network side to control the usage of the forwarding frequency (e.g., frequency f2) for radio resource measurement and cross interference management. On the other hand, enabling the data forwarding in a collaborative UE/Panel may increase the total power consumption from UE site and it may not be needed if the requested data rate is low.

It is desired for the UE and the network to manage the data forwarding operation dynamically and efficiently. Accordingly, how to boost MIMO performance adaptively and appropriately becomes an important issue in the newly developed wireless communication network. Therefore, there is a need to provide proper schemes to control the data forwarding operation.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to MIMO operation with respect to user equipment and network apparatus in mobile communications.

In one aspect, a method may involve an apparatus receiving a capability enquiry in a first frequency from a network node. The method may also involve the apparatus transmitting a capability report to the network node to indicate a supportability of a data forwarding operation with a collaborating apparatus in a second frequency. The method may further involve the apparatus receiving a configuration to enable or disable the data forwarding operation with the collaborating apparatus. The method may further involve the apparatus performing the data forwarding operation according to the configuration.

In one aspect, a method may involve a network node transmitting a capability enquiry in a first frequency to a primary apparatus. The method may also involve the network node receiving a capability report from the primary apparatus for indicating a supportability of a data forwarding operation with a collaborating apparatus in a second frequency. The method may further involve the network node transmitting a configuration to enable or disable the data forwarding operation with the collaborating apparatus.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2A is a diagram depicting an example scenario under schemes in accordance with implementations of the present disclosure.

FIG. 2B is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhancing MIMO operation with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

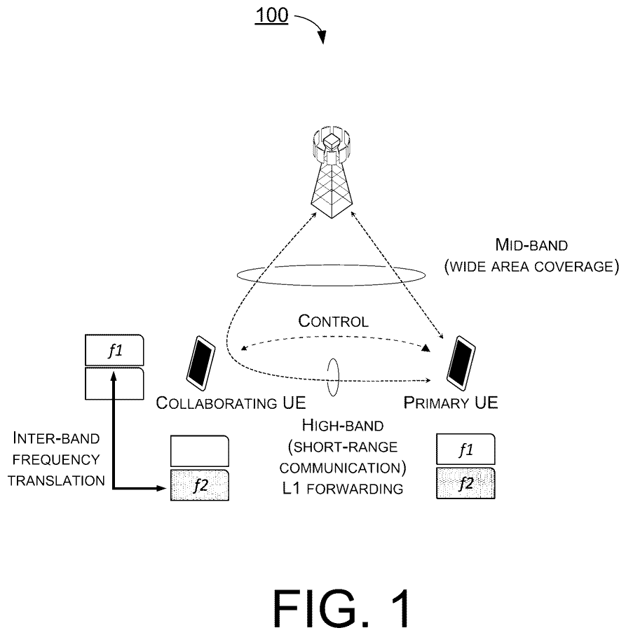

FIG. 1 illustrates an example scenario 100 under schemes in accordance with implementations of the present disclosure. Scenario 100 involves at least a primary UE, a collaborative UE and a network node, which may be a part of a wireless communication network (e.g., an LTE network, a 5G/NR network, an IoT network or a 6G network). Scenario 100 illustrates the framework of data forwarding operation in a communication system. The primary UE may expand its MIMO capability (e.g., effective number of MIMO layer) by using data forwarding via the collaborating UE. Specifically, the primary UE may directly communication with the network node (e.g., gNB) in a first frequency f1. The first frequency f1 may comprise a mid-band frequency (e.g., frequency range 1 (FR1)) which has wide area coverage and is suitable for long-range communication. In addition to the direct communication with the network node, the primary UE may establish an indirect communication with the network node via the collaborating UE. The collaborating UE may communication with the primary UE in a second frequency f2. The second frequency f2 may comprise a high-band frequency (e.g., frequency range 2 (FR2)) which has high data rate and is suitable for short-range communication. For long-range communication, the collaborating UE may also communication with the network node in the first frequency f1. Thus, the collaborating UE may perform an inter-band frequency translation to translate the first frequency f1 into the second frequency f2 or translate the second frequency f2 into the first frequency f1. The collaborating UE may help forward the data transmission between the primary UE and the network node. The data forwarding performed by the collaborating UE may comprise the layer 1 (L1) forwarding or the layer 2 (L2) forwarding.

To support the data forwarding via another frequency (e.g., forwarding Uu interface data in frequency f1 by using frequency f2, and vice versa), there is a need for the network node (e.g., gNB) to control the usage of the forwarding frequency (e.g., frequency f2) for radio resource measurement. The forwarding frequency should be properly selected/configured to avoid interferences, maintain channel qualities and improve radio resource efficiency. It is desired to provide proper time-frequency resource allocation for the data forwarding operation. On the other hand, enabling the data forwarding in a collaborative UE may increase the total power consumption at the UE site. However, the additional power consumption may not be need/necessary if the requested data rate or data amount is low. In other words, the data forwarding operation may not be always needed or activated. Therefore, it is desired to turn on/off or enable/disable the collaborative UE (e.g., the UE-controlled repeater) dynamically and/or indicate this preference to the network node to improve power management.

In view of the above, the present disclosure proposes some schemes pertaining to enhancing MIMO operation with collaborating UE with respect to UE and network apparatus in mobile communications. According to the schemes of the present disclosure, the network node may manage the frequencies (i.e., radio resources) used for the data forwarding operation. The network node may also enable or disable the data forwarding operation dynamically based on some conditions. On the other hand, the UE may measure and report some candidate frequencies configured for the data forwarding operation. The UE may also indicate its preference on enabling or disabling the data forwarding operation. Accordingly, the radio resource efficiency and the power consumption can be improved.

From network node's perspective, several schemes for managing the frequencies used for data forwarding/repeating are proposed. Specifically, if there are frequencies reserved/pre-allocated for data forwarding/repeating purpose, the network node may directly/blindly configure the frequencies to some UEs (e.g., primary UE and/or collaborating UE) as needed. Since those frequencies are reserved for data forwarding/repeating purpose (only), interferences or conflicts on those frequencies should be low and can be directly/blindly used/configured for data forwarding operation. The frequencies reserved for data forwarding/repeating may be pre-defined in 3rd Generation Partnership Project (3GPP) specifications or pre-configured to the network side.

In another scheme, network node may configure a list of candidate data forwarding/repeating frequencies for the UE to measure and report. If the UE reports very low signal quality (e.g., Signal to Interference and Noise Ratio (SINR) or Reference Signals Received Power (RSRP)) on that frequency, it implies that the frequency is not used by network in this area (i.e., the frequency is available for use). Then, the network node may configure that frequency to a UE for data forwarding/repeating purpose. For example, in a reporting event, when a neighbor frequency becomes worse than a threshold value, the UE may report the neighbor frequency to the network node and the neighbor frequency may be used for data forwarding/repeating.

In another scheme, after configuring the forwarding frequency, the network node may enable or disable the data forwarding operation of downlink/uplink operation if needed. The network node may configure the enable or disabling of data forwarding operation based on UE's preferences. Alternatively, the network node may directly enable or disable the data forwarding operation without the indication from the UE.

From UE's perspective, several schemes for managing the enabling or disabling of data forwarding/repeating are proposed. Specifically, the UE may indicate its capability together with the collaborative UE's capability. The UE may report that it is capable of MIMO operation enhancement by using another frequency (for short-range data forwarding) between the UE and its collaborative UE. The UE may also report the supported frequency bands (e.g., frequency band combinations) that can be used for frequency-translated forwarding on the collaborative UE. The supported frequency bands may depend on UE's (e.g., primary UE and/or collaborating UE) capabilities (e.g., hardware/software capabilities).

In another scheme, the UE may receive candidate frequencies for data forwarding from the network node. The UE may perform a measurement on the candidate frequencies and transmit a measurement result to the network node. Then, the network node may configure the data forwarding frequencies to the UE according to the measurement result reported by the UE. For example, the network node may determine which frequency is not used (i.e., is available) according to the measurement result and configure that frequency to the UE for data forwarding operation.

In another scheme, after being configured with the data forwarding frequency (e.g., f2), the UE may indicate the preference to enable or disable the data forwarding operation (i.e., frequency-translate function), if it wants to turn on or turn off its collaborative UE. The UE may also indicate a capability of MIMO layer and a capability of maximum transmit power to network node when the collaborative UE is turned on. In addition, after being configured with the data forwarding frequency, the UE may be allowed to indicate its preference of not enabling the data forwarding operation. For example, due to connection lost/failure between the primary UE and the collaborative UE or power saving purpose, the UE may indicate not to enable the data forwarding operation.

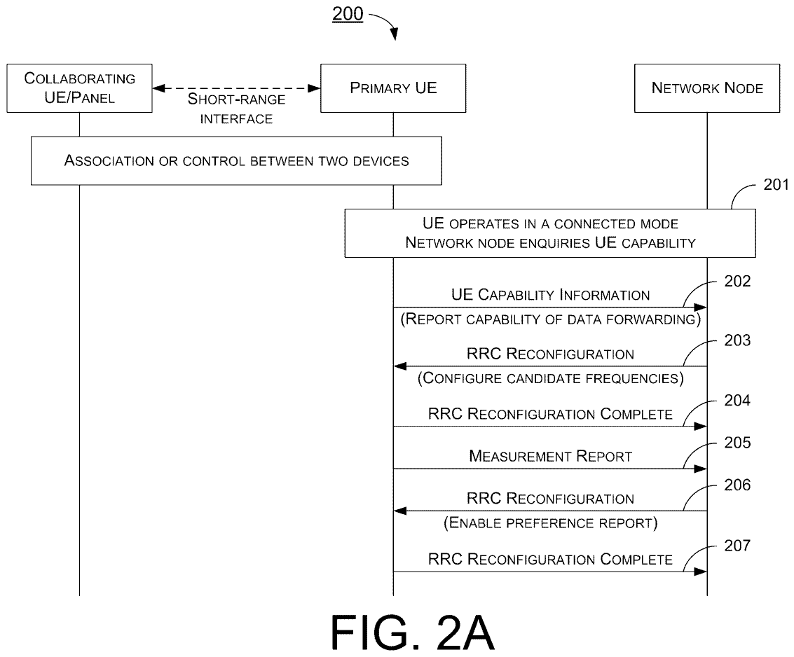

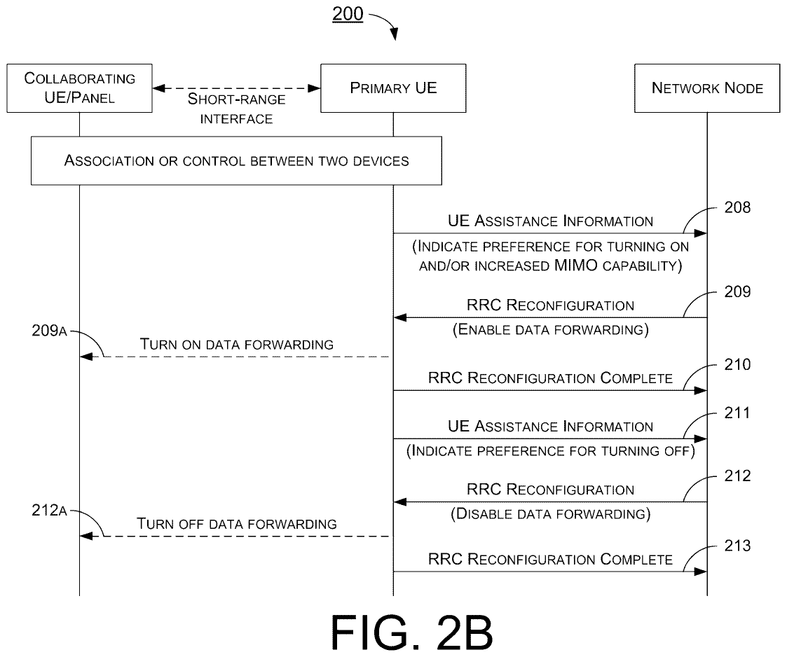

FIGS. 2A-2B illustrate an example scenario 200 under schemes in accordance with implementations of the present disclosure. Scenario 200 involves at least a primary UE, a collaborative UE and a network node, which may be a part of a wireless communication network (e.g., an LTE network, a 5G/NR network, an IoT network or a 6G network). Scenario 200 illustrates the signaling flow of data forwarding operation. The primary UE may communicate with the network node via a long-range interface (e.g., first frequency f1) and communicate with the collaborating UE via a short-range interface (e.g., second frequency f2). The association or control between the primary UE and the collaborating UE may comprise proprietary protocols.

In step 201, the primary UE may operate in a connected mode and the network node may enquiry the UE's capability (e.g., capability of the primary UE and/or the collaborative UE). For example, the network node may transmit a capability enquiry message to the primary UE. In step 202, the primary UE may transmit a capability report comprising UE capability information to the network node. The UE capability information may indicate a supportability of a data forwarding operation with the collaborating apparatus in the second frequency (e.g., f2). For example, the primary UE may indicate its support of using another frequency for short range data forwarding between the primary UE and its collaborative UE to enhance the MIMO operation. In addition, the primary UE may also report the capability of frequency bands or combinations that can be used for frequency-translated forwarding with the collaborative UE. The primary UE may determine the capability of frequency bands or combinations according to at least one of its hardware capabilities, software/firmware capabilities, supported bands provided by the service provider and regulations.

In step 203, the network node may transmit a radio resource control (RRC) reconfiguration message to the primary UE to configure a list of candidate data forwarding frequencies for the primary UE to measure and report. In step 204, the primary UE may transmit an RRC reconfiguration complete message to the network node. Then, the primary UE may perform a measurement on the list of candidate data forwarding frequencies. The primary UE may measure SINR or RSRP for the candidate data forwarding frequencies. In step 205, the primary UE may transmit a measurement report/result to the network node. The primary UE may report the data forwarding frequency according to some reporting events. For example, after the measurement, if the measurement result (e.g., SINR or RSRP) of a neighbor frequency becomes worse than a threshold value, it implies that the neighbor frequency is not used by the network. The primary UE may repot that neighbor frequency to the network node.

In some implementations, steps 203-205 may be optional. The network node may configure the data forwarding frequency blindly/directly without UE's measurement report. For example, for the frequencies reserved for short range communication, the network node may directly configure those frequencies to the primary UE for data forwarding operation and does not require the primary UE to measure and report.

In step 206, the network node may transmit an RRC reconfiguration message to the primary UE to configure some data forwarding frequencies for the primary UE to use and allow the primary UE to indicate its preference of enabling/disabling the data forwarding operation (i.e., enable UE preference report). Correspondingly, the primary UE may receive a resource allocation (e.g., the configured data forwarding frequencies) for the data forwarding operation from the network node. The primary UE may perform the data forwarding operation according to the resource allocation. In step 207, the primary UE may transmit an RRC reconfiguration complete message to the network node.

In step 208, the primary UE may transmit assistance information to the network node. The assistance information may indicate its preference to enable/turn on the data forwarding operation with the collaborative UE. The primary UE may determine the preference according to at least one of a power status, a data status and a connection status with the collaborating UE. For example, in a case that the remaining power and/or the buffered data is greater than a threshold value, the primary UE may indicate its preference to enable/turn on the data forwarding operation. In addition, the primary UE may also indicate its increased capability if the data forwarding operation is enabled/turned on. For example, the primary UE may indicate the increased MIMO layer and/or the increased maximum transmission power if the data forwarding operation is enabled/turned on.

In step 209, the network node may transmit an RRC reconfiguration message to the primary UE to enable the data forwarding operation. In step 209a, the primary UE may transmit a turn on indication to the collaborating UE in an event that the data forwarding operation is enabled. In step 210, the primary UE may transmit an RRC reconfiguration complete message to the network node.

In some implementations, the network node may enable the data forwarding operation directly without the indication or assistance information from the primary UE. The network node may determine to enable the data forwarding operation according to some conditions. For example, for some services requiring high data rate, the network node may directly enable the data forwarding operation.

In step 211, the primary UE may transmit assistance information to the network node. The assistance information may indicate its preference to disable/turn off the data forwarding operation with the collaborative UE. The primary UE may determine the preference according to at least one of a power status, a data status and a connection status with the collaborating UE. For example, in a case that the remaining power and/or the data buffered is less than a threshold value or the connection between the primary UE and the collaborating UE is lost or becomes bad, the primary UE may indicate its preference to disable/turn off the data forwarding operation.

In step 212, the network node may transmit an RRC reconfiguration message to the primary UE to disable the data forwarding operation. In step 212a, the primary UE may transmit a turn off indication to the collaborating UE in an event that the data forwarding operation is disabled. In step 213, the primary UE may transmit an RRC reconfiguration complete message to the network node.

In some implementations, the network node may disable the data forwarding operation directly without the indication or assistance information from the primary UE. The network node may determine to disable the data forwarding operation according to some conditions. For example, for some services only requiring low data rate, the network node may directly disable the data forwarding operation to save the power consumption of the primary UE.

### Illustrative Implementations

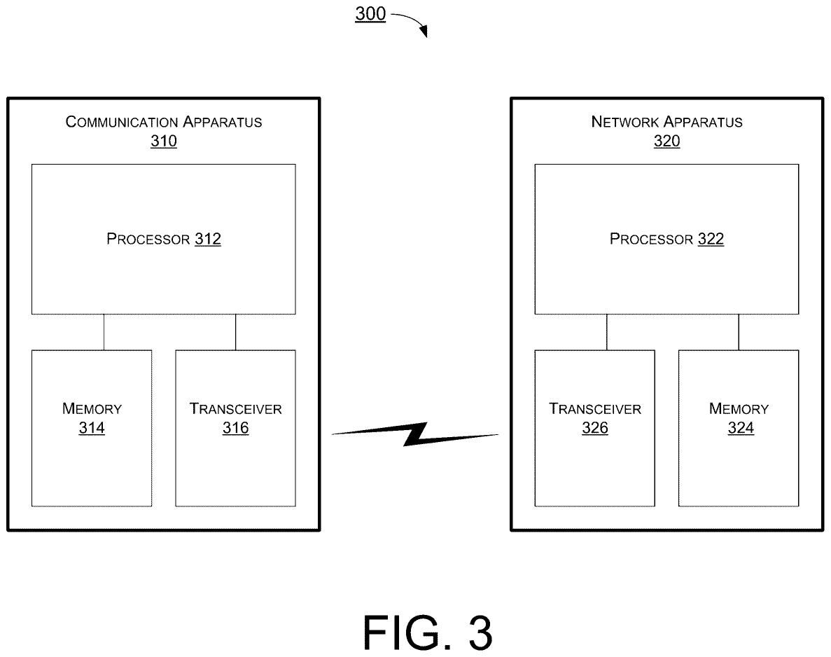

FIG. 3 illustrates an example communication system 300 having at least an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to enhancing MIMO operation in mobile communications, including the various schemes described above with respect to various proposed designs, concepts, schemes, systems and methods described above, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, smart glasses, an augmented reality/virtual reality (AR/VR) device, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for MIMO wireless communications. In some implementations, network apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, communication apparatus 310 may further include a memory 314 coupled to processor 312 and capable of being accessed by processor 312 and storing data therein. In some implementations, network apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 314 and memory 324 may include a UICC.

Under certain proposed schemes in accordance with the present disclosure with respect to enhancing MIMO operation in mobile communications, processor 312 may receive, via transceiver 316, a capability enquiry in a first frequency from network apparatus 320. Processor 312 may transmit, via transceiver 316, a capability report to network apparatus 320 to indicate a supportability of a data forwarding operation with a collaborating apparatus in a second frequency. Processor 312 may receive, via transceiver 316, a configuration to enable or disable the data forwarding operation with the collaborating apparatus. Processor 312 may perform the data forwarding operation according to the configuration.

In some implementations, processor 312 may report, via transceiver 316, at least one supported frequency band combination for the data forwarding operation to network apparatus 320.

In some implementations, processor 312 may receive, via transceiver 316, a list of candidate data forwarding frequencies from network apparatus 320. Processor 312 may perform a measurement on the list of candidate data forwarding frequencies. Processor 312 may transmit, via transceiver 316, a measurement result to network apparatus 320. The measurement result may be transmitted according to a reporting event.

In some implementations, processor 312 may receive, via transceiver 316, a resource allocation for the data forwarding operation from network apparatus 320. Processor 312 may perform the data forwarding operation according to the resource allocation.

In some implementations, processor 312 may transmit, via transceiver 316, a preference of enabling or disabling the data forwarding operation to network apparatus 320.

In some implementations, processor 312 may determine the preference according to at least one of a power status, a data status and a connection status with the collaborating apparatus.

In some implementations, processor 312 may indicate at least one of a capability of MIMO layer and a capability of maximum transmit power to network apparatus 320 in an event that the data forwarding operation is enabled.

In some implementations, processor 312 may transmit, via transceiver 316, a turn on indication to the collaborating apparatus in an event that the data forwarding operation is enabled.

In some implementations, processor 312 may transmit, a turn off indication to the collaborating apparatus in an event that the data forwarding operation is disabled.

In some implementations, the data forwarding operation may be enabled to increase at least one of a MIMO performance and a maximum transmit power of communication apparatus 310.

In some implementations, processor 322 may transmit, via transceiver 326, a capability enquiry in a first frequency to communication apparatus 310. Processor 322 may receive, via transceiver 326, a capability report from communication apparatus 310 for indicating a supportability of a data forwarding operation with a collaborating apparatus in a second frequency. Processor 322 may transmit, via transceiver 326, a configuration to enable or disable the data forwarding operation with the collaborating apparatus.

In some implementations, processor 322 may receive, via transceiver 326, at least one supported frequency band combination for the data forwarding operation from communication apparatus 310.

In some implementations, processor 322 may configure a list of candidate data forwarding frequencies to communication apparatus 310. Processor 322 may receive, via transceiver 326, a measurement result associated with the list of candidate data forwarding frequencies from communication apparatus 310.

In some implementations, processor 322 may determine at least one data forwarding frequency for the data forwarding operation according to the measurement result. Processor 322 may configure the determined data forwarding frequency to communication apparatus 310.

In some implementations, processor 322 may configure a resource allocation for the data forwarding operation to communication apparatus 310. The resource allocation may comprise at least one frequency reserved for the data forwarding operation.

In some implementations, processor 322 may receive, via transceiver 326, a preference of enabling or disabling the data forwarding operation from communication apparatus 310.

In some implementations, processor 322 may determine the configuration to enable or disable the data forwarding operation according to the preference.

In some implementations, processor 322 may receive, via transceiver 326, at least one of a capability of MIMO layer and a capability of maximum transmit power from communication apparatus 310 in an event that the data forwarding operation is enabled.

In some implementations, processor 322 may configure a turn on indication for the collaborating apparatus in an event that the data forwarding operation is enabled.

In some implementations, processor 322 may configure a turn off indication for the collaborating apparatus in an event that the data forwarding operation is disabled.

### Illustrative Processes

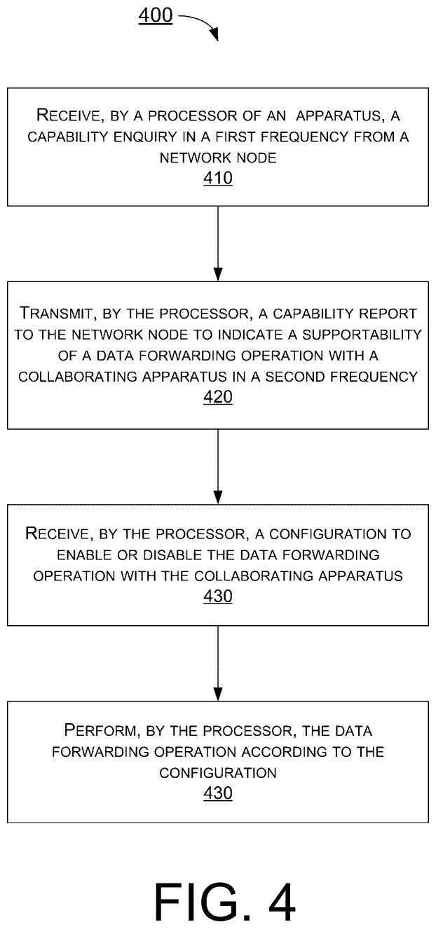

FIG. 4 illustrates an example process 400 in accordance with an implementation of the present disclosure. Process 400 may be an example implementation of above scenarios/schemes, whether partially or completely, with respect to enhancing MIMO operation with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At block 410, process 400 may involve processor 312 of communication apparatus 310 receiving a capability enquiry in a first frequency from a network node. Process 400 may proceed from block 410 to block 420.

At block 420, process 400 may involve processor 312 transmitting a capability report to the network node to indicate a supportability of a data forwarding operation with a collaborating apparatus in a second frequency. Process 400 may proceed from block 420 to block 430.

At block 430, process 400 may involve processor 312 receiving a configuration to enable or disable the data forwarding operation with the collaborating apparatus. Process 400 may proceed from block 430 to block 440.

At block 440, process 400 may involve processor 312 performing the data forwarding operation according to the configuration.

In some implementations, the first tier CSI or the second tier CSI may comprise a first subset of channel parameters including at least one basis selection in at least one of a spatial domain, a frequency domain and a Doppler domain.

In some implementations, process 400 may involve processor 312 reporting at least one supported frequency band combination for the data forwarding operation to the network node.

In some implementations, process 400 may involve processor 312 receiving a list of candidate data forwarding frequencies from the network node. Process 400 may also involve processor 312 performing a measurement on the list of candidate data forwarding frequencies. Process 400 may further involve processor 312 transmitting a measurement result to the network node.

In some implementations, process 400 may involve processor 312 transmitting the measurement result according to a reporting event.

In some implementations, process 400 may involve processor 312 receiving a resource allocation for the data forwarding operation from the network node. In some implementations, process 400 may also involve processor 312 performing the data forwarding operation according to the resource allocation.

In some implementations, process 400 may involve processor 312 transmitting a preference of enabling or disabling the data forwarding operation to the network node.

In some implementations, process 400 may involve processor 312 determining the preference according to at least one of a power status, a data status and a connection status with the collaborating apparatus.

In some implementations, process 400 may involve processor 312 indicating at least one of a capability of MIMO layer and a capability of maximum transmit power to the network node in an event that the data forwarding operation is enabled.

In some implementations, process 400 may involve processor 312 transmitting a turn on indication to the collaborating apparatus in an event that the data forwarding operation is enabled.

In some implementations, process 400 may involve processor 312 transmitting a turn off indication to the collaborating apparatus in an event that the data forwarding operation is disabled.

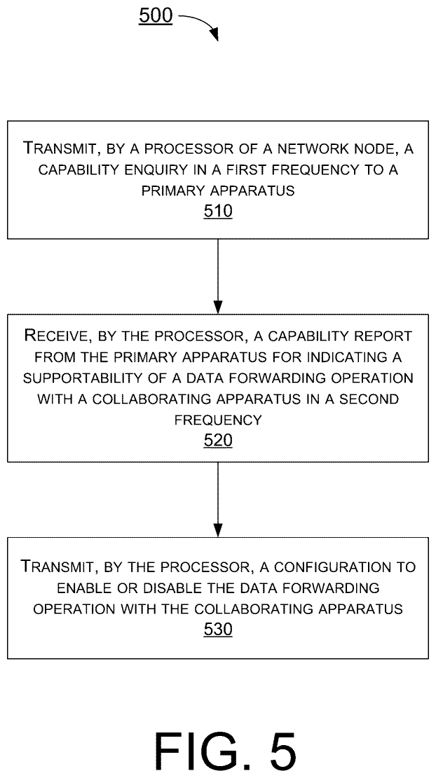

FIG. 5 illustrates an example process 500 in accordance with an implementation of the present disclosure. Process 500 may be an example implementation of above scenarios/schemes, whether partially or completely, with respect to enhancing MIMO operation with the present disclosure. Process 500 may represent an aspect of implementation of features of network apparatus 320. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any suitable base station or network node. Solely for illustrative purposes and without limitation, process 500 is described below in the context of network apparatus 320. Process 500 may begin at block 510.

At block 510, process 500 may involve processor 322 of network apparatus 320 transmitting a capability enquiry in a first frequency to a primary apparatus. Process 500 may proceed from block 510 to block 520.

At block 520, process 500 may involve processor 322 receiving a capability report from the primary apparatus for indicating a supportability of a data forwarding operation with a collaborating apparatus in a second frequency. Process 500 may proceed from block 520 to block 530.

At block 530, process 500 may involve processor 322 transmitting a configuration to enable or disable the data forwarding operation with the collaborating apparatus.

In some implementations, process 500 may involve processor 322 receiving at least one supported frequency band combination for the data forwarding operation from the primary apparatus.

In some implementations, process 500 may involve processor 322 configuring a list of candidate data forwarding frequencies to the primary apparatus. Process 500 may also involve processor 322 receiving a measurement result associated with the list of candidate data forwarding frequencies from the primary apparatus.

In some implementations, process 500 may involve processor 322 determining at least one data forwarding frequency for the data forwarding operation according to the measurement result. Process 500 may also involve processor 322 configuring the determined data forwarding frequency to the primary apparatus.

In some implementations, process 500 may involve processor 322 configuring a resource allocation for the data forwarding operation to the primary apparatus. The resource allocation may comprise at least one frequency reserved for the data forwarding operation.

In some implementations, process 500 may involve processor 322 receiving a preference of enabling or disabling the data forwarding operation from the primary apparatus.

In some implementations, process 500 may involve processor 322 determining the configuration to enable or disable the data forwarding operation according to the preference.

In some implementations, process 500 may involve processor 322 receiving at least one of a capability of MIMO layer and a capability of maximum transmit power from the primary apparatus in an event that the data forwarding operation is enabled.

In some implementations, process 500 may involve processor 322 configuring a turn on indication for the collaborating apparatus in an event that the data forwarding operation is enabled.

In some implementations, process 500 may involve processor 322 configuring a turn off indication for the collaborating apparatus in an event that the data forwarding operation is disabled.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a capability enquiry in a first frequency from a network node;
transmitting, by the processor, a capability report to the network node to indicate a supportability of a data forwarding operation with a collaborating apparatus in a second frequency;
receiving, by the processor, a configuration to enable or disable the data forwarding operation with the collaborating apparatus; and
performing, by the processor, the data forwarding operation according to the configuration.

2. The method of claim 1, further comprising:
reporting, by the processor, at least one supported frequency band combination for the data forwarding operation to the network node.

3. The method of claim 1, further comprising:
receiving, by the processor, a list of candidate data forwarding frequencies from the network node;
performing, by the processor, a measurement on the list of candidate data forwarding frequencies; and
transmitting, by the processor, a measurement result to the network node.

4. The method of claim 3, wherein the measurement result is transmitted according to a reporting event.

5. The method of claim 1, further comprising:
receiving, by the processor, a resource allocation for the data forwarding operation from the network node;
performing, by the processor, the data forwarding operation according to the resource allocation.

6. The method of claim 1, further comprising:
transmitting, by the processor, a preference of enabling or disabling the data forwarding operation to the network node.

7. The method of claim 6, further comprising:
determining, by the processor, the preference according to at least one of a power status, a data status and a connection status with the collaborating apparatus.

8. The method of claim 1, further comprising:
indicating, by the processor, at least one of a capability of multiple-input multiple-output (MIMO) layer and a capability of maximum transmit power to the network node in an event that the data forwarding operation is enabled.

9. The method of claim 1, further comprising:
transmitting, by the processor, a turn on indication to the collaborating apparatus in an event that the data forwarding operation is enabled; or
transmitting, by the processor, a turn off indication to the collaborating apparatus in an event that the data forwarding operation is disabled.

10. The method of claim 1, wherein the data forwarding operation is enabled to increase at least one of a multiple-input multiple-output (MIMO) performance and a maximum transmit power.

11. A method, comprising:
transmitting, by a processor of a network node, a capability enquiry in a first frequency to a primary apparatus;
receiving, by the processor, a capability report from the primary apparatus for indicating a supportability of a data forwarding operation with a collaborating apparatus in a second frequency; and
transmitting, by the processor, a configuration to enable or disable the data forwarding operation with the collaborating apparatus.

12. The method of claim 11, further comprising:
receiving, by the processor, at least one supported frequency band combination for the data forwarding operation from the primary apparatus.

13. The method of claim 11, further comprising:
configuring, by the processor, a list of candidate data forwarding frequencies to the primary apparatus; and
receiving, by the processor, a measurement result associated with the list of candidate data forwarding frequencies from the primary apparatus.

14. The method of claim 13, further comprising:
determining, by the processor, at least one data forwarding frequency for the data forwarding operation according to the measurement result; and
configuring, by the processor, the determined data forwarding frequency to the primary apparatus.

15. The method of claim 11, further comprising:
configuring, by the processor, a resource allocation for the data forwarding operation to the primary apparatus.

16. The method of claim 15, wherein the resource allocation comprises at least one frequency reserved for the data forwarding operation.

17. The method of claim 11, further comprising:
receiving, by the processor, a preference of enabling or disabling the data forwarding operation from the primary apparatus.

18. The method of claim 17, further comprising:
determining, by the processor, the configuration to enable or disable the data forwarding operation according to the preference.

19. The method of claim 11, further comprising:
receiving, by the processor, at least one of a capability of multiple-input multiple-output (MIMO) layer and a capability of maximum transmit power from the primary apparatus in an event that the data forwarding operation is enabled.

20. The method of claim 11, further comprising:
configuring, by the processor, a turn on indication for the collaborating apparatus in an event that the data forwarding operation is enabled; or
configuring, by the processor, a turn off indication for the collaborating apparatus in an event that the data forwarding operation is disabled.
